(19) United States
(12) Patent Application Publication
(10) Pub. No.: US 2004/0139182 A1
(43) Pub. Date: Jul. 15, 2004

(54) Management device and method for controlling an internet website browsing

(76) Inventors: Chi-Tung Chang, Taipei (TW); Robert Gorden Thunell, Taipei (TW)

Correspondence Address: Alcor Micro, Corp., P. O. Box No.6-57, Chung-Ho, Taipei, 235, TW

(21) Appl. No.: 10/307,331

(22) Filed: Dec. 2, 2002

(51) Int. Cl. G06F 15/173

(52) U.S. Cl. 709/223

(57) ABSTRACT

A management device and method for controlling an internet website browsing includes at least a logic controlling chip circuit, a memory, an electric connector for connecting a computer and a driving software relative to an internet setting; wherein, the logic controlling chip reads data set and stored in a flash memory; the control of the driving software manages the authority function and access setting of using the internet through the computer thereby effectively managing the online time, the position of an openable or restricted website and the access of carried operation data so as to effectively achieve the objective of managing and protecting the children from browsing an erotic or violent website.

### BACKGROUND OF THE INVENTION

1) Field of the Invention

The present invention relates to a management device and method for controlling an internet website browsing; the present invention uses an available electric connector disposed with a memory as the base (so called a portable mobile disk of a universal serial bus connector) to connect a management device with a computer; first, an application software is installed inside the computer to determine whether the computer has the authority and ability to go online; a management code and authority setting recorded in a memory inside the management device sequentially release the authority thereby effectively monitoring and managing the internet application.

2) Description of the Prior Art

Internet has become an indispensable tool in the modern society. It shortens the distance among people and its ubiquity expands more business opportunities. It seems that nothing is impossible in the internet world.

However, many unhealthy websites with erotic, violent or gambling contents exist in the internet for the same reason. Without proper management, these kinds of websites definitely cause unnecessary harm to students. In viewing the disadvantage of the situation, the present invention manages the monitoring through both of the software and hardware so as to eliminate the damage caused by an unhealthy website.

The corn port and the print port available on the market are the exemplary key protectors for controlling the software application authority. They are techniques developed in the early stage. However, their functions are only for the purpose of limiting the application authority or time effectiveness of the software.

In addition, a universal serial bus (USB) electric connector is a serial bus compatibly used for current digital transmission. Many computers and periphery equipment adapt its dimension for the interface of a transmission joint. Its advantage is that the same connector is used for connecting a plurality of periphery equipment of different dimensions with a computer thereby eliminating the shortcoming of exclusive usage of the connector. Based on its advantage, the products of the post-development of USB connection interface are numerous, such as a card reader, a mobile disk, a mobile phone charger. They all use the USB transmission to directly connect with the computer online for extensive application. The present invention of a management device and method of controlling an internet website browsing also uses USB electric connector.

### SUMMARY OF THE INVENTION

The present invention of a management device and method for controlling an internet website browsing improved the abovementioned mobile disk (so called a portable and mobile disk of a USN connector) and added a function for controlling and managing the internet. The present invention comprises at least a logic controlling chip circuit, a memory, an electric connector for connecting a computer and a driving software relative to an internet setting; wherein the electric connector connects the management device with the computer; the logic controlling chip reads and accesses data set inside the memory to allow a controlling software to manage the setting of a user's internet authority and access function. Students or young children can store or access their school work or communication items in the memory of the present invention. Through this device, they can also go online via their computers such that parents and teachers are able to know which website have been browsed by them. Furthermore, the present invention is capable of limiting or prohibiting certain websites from being browsed so as to efficiently monitor or manage the internet application.

The primary objective of the present invention of a management device and method for controlling an internet website browsing is to improve a portable mobile disk added with the functions of controlling and managing the internet. A controlling chip reads and stores part of the memory; wherein the memory records the position of an acceptable or unacceptable website as well as the online time so as to monitor the scope of the websites to be visited and the time spent by the user.

Another objective of the present invention is to utilize the function of using the logic controlling chip inside a storage device for identifying the code so as to achieve the objective of allowing the computer to be online or not. The user is allowed to go online only if the code has been confirmed.

The present invention of a management device and method for controlling an internet website browsing comprises at least a logic controlling chip circuit, a memory, an electric connector for connecting a computer with a driving software relative to an internet setting; wherein, the logic controlling chip reads data set and stored in a memory as well as utilize part of the memory for access through the control and access of the intemet setting via an application software and the driving software; the logic control chip controls the access; the software installed inside the computer controls the online ability of the computer; the objective is to use a storage device of a portable flash memory and a relative software connecting with various types of computer internet settings so as to control the internet website browsing.

To enable a further understanding of achieving the abovementioned objectives and the technical contents of the present invention, the brief description is followed by the drawings and the detailed description of a preferred embodiment.

### BRIEF DESCRIPTION OF THE DRAWINGS

FIG. 1 is a schematic drawing of the installation of an application software and a management device of the present invention.

FIG. 2A is the first flow chart of the operation of the present invention.

FIG. 2B is the second flow chart of the operation of the present invention.

### DETAILED DESCRIPTION OF THE PREFERRED EMBODIMENTS

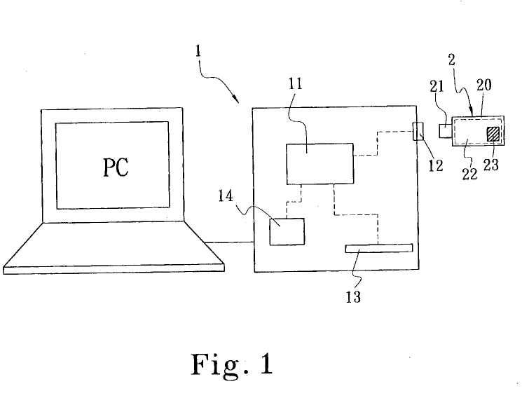

FIG. 1 shows a schematic drawing of the installation of an application software and a management device of the present invention of a management device and method for controlling the internet website browsing. First, the application software (11) is installed inside the computer (1) in a normal status. Activating the computer (1) synchronously activates the application software (11) to actively detect whether a connection port (12) connects with a management device (2) of the present invention. If the detection shows the existence of the management device (2), the next step will be taken. Otherwise, the application software (11) interrupts the connected operation of an internet browser (14) or constrains the job of an internet card (13) to prevent the computer (1) from using the network.

In addition, the management device of the present invention comprises a main body (20), an electric connector (21), a logic controlling chip (22) and a memory (23); wherein, the electric connector (21) connects with the connection port (12) of the computer (1) to transmit data and provide electric power. The main body (20) comprises the logic controlling chip (22) and the memory (23); through the connection between the electric connector (21) and the computer (1), the logic controlling chip (22) is in charge of accessing the data in the memory (23); the memory is in charge of storing the website data and the authority data of the online time to be accessed by the application software (11) in the computer (1) so as to determine the online authority and sequentially release the conditions limited by the application software (11) for use.

The preferred embodiment of the connection of the management device (2) of the present invention and the computer (1) is indicated by a universal serial bus joint (211). The other embodiments include a printer port, a com port, IEEE1394, RJ45 215 and an infrared transmission method. The main objective thereof is to allow the authority data stored in the memory (23) inside the management device (2) to be accessed by the application software (11) of the computer (1). The memory (23) can be a built-in memory (DRAM) or an external memory, such as a CF Card, a Smart Card or a hard disk. The objective thereof is to enable the management device (2) to have the storage function so as to efficiently manage the setting of the user's usage authority or act as an access device to store the user's data or file to be carried.

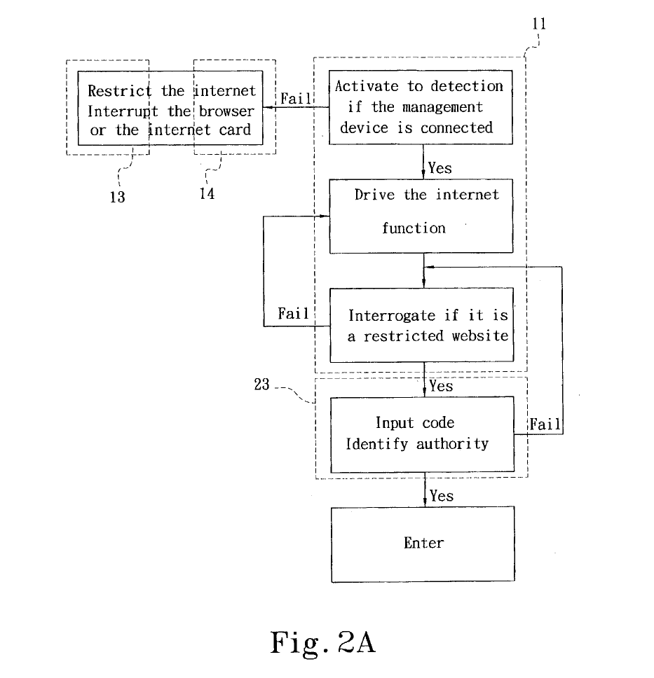

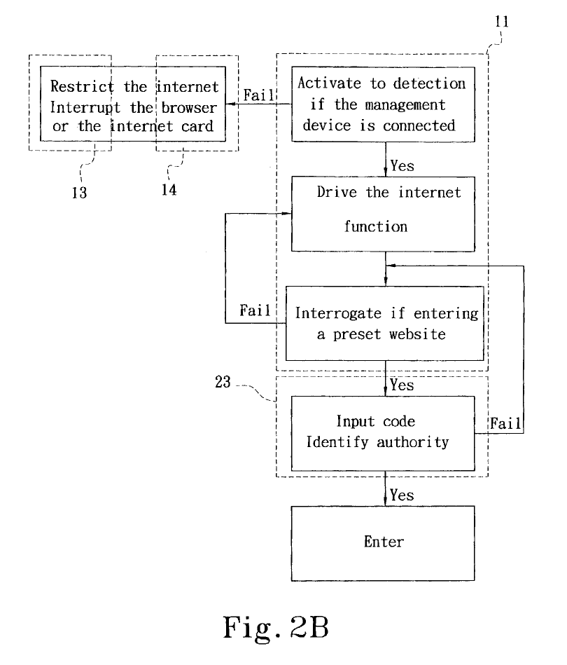

FIG. 2A shows the first operation flow chart of the present invention. The user installs the application software (11) into the computer (1); activating the computer (1) synchronously activates the application software (11) to detect whether the management device (2) connects with the connection port (12) of the computer (1). Without the identification of the management device (2), the application software (11) influences the operation of the internet browser (14) or constrains the job of the internet card (13), as shown in FIG. 1, thereby disabling the computer (1) to use the internet. Contrarily, if the result of detection shows that the management device (2) is connected, then the computer (1) is allowed to use the internet; the website data and time spent online will be recorded. However, any website listed and stored in the memory (23) will not be opened for use. The management mechanism thereof uses the IP position of the website or any erotic or violent words contained in the pages as the base for screening. When the user tries to enter a restricted website, the application software (11) requests the code identification from the memory (23) of the management device (2). The management personnel sets up the user's authority in the application software (11), changes the code, edits the required website data and reads the relative data.

According to the abovementioned, if the result of detection shows that the management device (2) is connected, then the computer (1) is allowed to use the internet. FIG. 2B shows that different situations occur when the different conditions are applied between the memory (23) and the application software (11).

1. Preset the website to be managed as the restricted one:

The memory (23) of the management device (2) is for storing the position of a restricted website; when trying to enter a certain website online, the user has to pass the detection of the storage device of the memory (23). If it belongs to one of the restricted website recorded in the memory (23), then the application software (11) requests the code input. However, those websites not belonging to the restricted websites recorded in the memory (23) will not be controlled by the management device (2). The restricted website in the memory (23) will be opened only when the code is identified. The management personnel edits or changes the authority of the code at any time thereby efficiently controlling the application of the internet.

2. Pre-store the website to be opened in the memory (23):

The memory (23) of the management device (2) stores the websites to be opened. When the user tries to use the internet, it is necessary to identify the code first; only the correct identification permits the user to go online; however, the IP is limited to the website listed in the memory. The management personnel edits or changes the authority of the code at any time thereby efficiently controlling the application of the internet.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A management device and method for controlling an internet website browsing includes at least a logic controlling chip circuit, a memory, an electric connector for connecting a computer and a driving software relative to an internet setting; the present invention mainly uses the embodiment of a portable mobile disk of a currently available universal serial bus electric connector and adds a management device to control the link between the user and internet so as to eliminate the children from entering the unhealthy website, wherein:
the logic controlling chip reads the data inside the memory, accesses the internet setting through the control of an application software and utilizes part of the memory to provide access to be controlled by the logic controlling chip;
a memory accesses the setting of a user's authority data; a part of the space thereof is used for accessing the data;
an electric connector connects the management device and the computer main unit for transmitting the data access between them;
wherein the logic controlling chip reads the storage data set inside a flash memory and manages the internet usage authority and the access setting of a computer so as to efficiently manage the opening of the online time, limit the website position or access the carried operation data thereby effectively managing and preventing the children from the browsing the erotic or violent website.

2. The management device and method for controlling an internet website browsing according to claim 1, wherein the electric connector of the present invention uses a universal serial bus connector for a preferred embodiment to provide the signal or electric power supply.

3. The management device and method for controlling an internet website browsing according to claim 1, wherein the code identification data for linking the internet is obtained from an application software data base.

4. The management device and method for controlling an internet website browsing according to claim 1, wherein the code identification data for linking the internet is obtained from a memory device via the logic controlling chip.
